(19) United States
(12) Patent Application Publication
(10) Pub. No.: US 2009/0133890 A1
(43) Pub. Date: May 28, 2009

(54) Power Tool Attachments

(76) Inventor: Paul Edward Duggan, Cambridge (GB)

Correspondence Address: NIXON & VANDERHYE, PC, 901 NORTH GLEBE ROAD, 11TH FLOOR, ARLINGTON, VA, 22203, US

(21) Appl. No.: 12/090,184

(22) PCT Filed: Oct. 12, 2006
(86) PCT No.: PCT/GB06/03785

§ 371 Date: Jul. 8, 2008

(30) Foreign Application Priority Data
Oct. 14, 2005 (GB) 0520911.9

(51) Int. Cl. B25D 9/00

(52) U.S. Cl. 173/132

(57) ABSTRACT

An attachment is for a power tool having a chuck. The attachment has a connection portion in the form of a shaft for connecting the attachment with the tool, during use, by attachment in the chuck. The attachment further has a blade portion which, in use, is offered to a surface indicated at, and to which hammer blows are transmitted from the hammer tool, thereby causing the blade portion to cut into the surface.

The present invention relates to attachments for power tools.

The invention provides an attachment for a powered hammer tool, having a connection portion for connecting the attachment with a tool, during use, and a blade portion which, in use, is offered to a surface and to which, in use, hammer blows are transmitted from the hammer tool, thereby causing the blade portion to cut into the surface.

The blade preferably has an elongate working edge, which is preferably straight. The blade may be formed at one end of the working edge to have a concavity away from the working edge, forming a convex nib at the end of the working edge. The blade may be formed at one end of the working edge to have an edge extending away from the working edge and meeting the end of the working edge at an acute angle. There may be a cutting medium carried by the blade at or near the working edge, such as a hard grit, such as a tungsten carbide grit.

Preferably, a cushion portion is associated with the blade, the blade projecting beyond the cushion portion by a projection length which defines the depth to which the blade is able to penetrate the surface. The blade is preferably adjustable in position relative to the cushion portion, to set the maximum depth of penetration into the surface. The or a cushion portion is preferably provided to both sides of the blade and may be provided by a gasket extending around the blade, or a plurality of separate cushion members.

The blade is preferably removable from the connection portion. The connection portion may comprise a main body, and a clamp arrangement to clamp the blade to the main body.

The clamp arrangement may include at least one elongate clamp member which extends through the blade. The clamp member may extend through a slot in the blade, the slot allowing the blade position to be adjustable when the clamp arrangement is tightened.

The main body preferably has a surface through which hammer blows are transmitted to the blade when in abutment therewith, there being a filler member locatable between the blade and the surface when the blade is spaced away from the surface, to convey hammer blows through the filler member to the blade.

The connection portion is preferably adapted to receive a plurality of spaced blades. The spacing of the blades may be adjustable. There may be spacer members locatable between spaced blades to maintain a spacing set by the thickness and/or number of spacers.

The blade and connection portion may form a unitary article. The connection portion may be moulded around the blade.

The connection portion may comprise a main body carrying the blade portion, and a shaft connected to the main body to be received, in use, by the powered hammer tool. There may be an articulated connection between the shaft and the main body.

Examples of the present invention will now be described in more detail, by way of example only, and with reference to the accompanying drawings, in which:

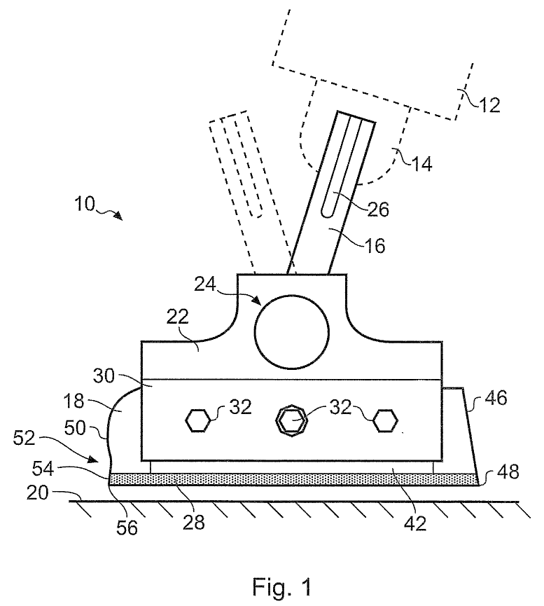

FIG. 1 is a front elevation of one example of an attachment for a powered hammer tool;

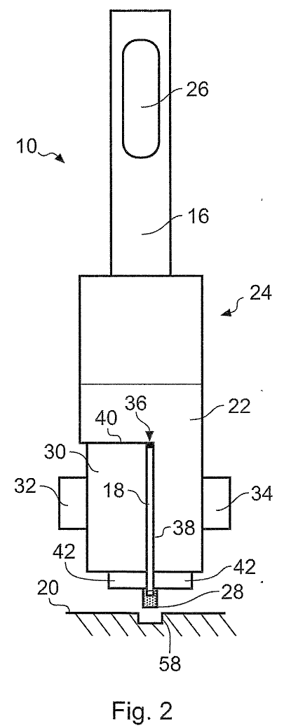

FIG. 2 is a side elevation of the attachment of FIG. 1;

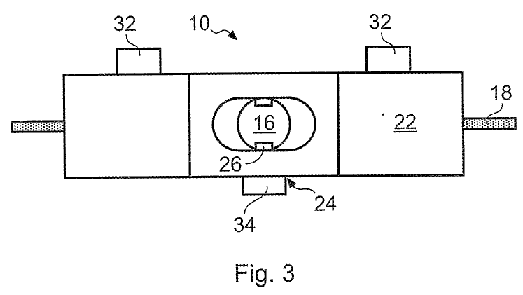

FIG. 3 is a plan view of the attachment of FIG. 1;

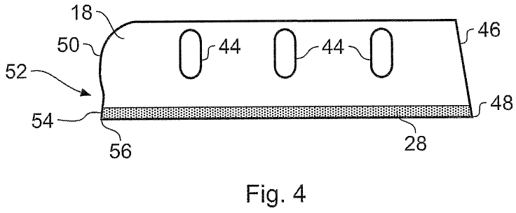

FIG. 4 is a front elevation of a blade portion for use in the attachment of FIG. 1;

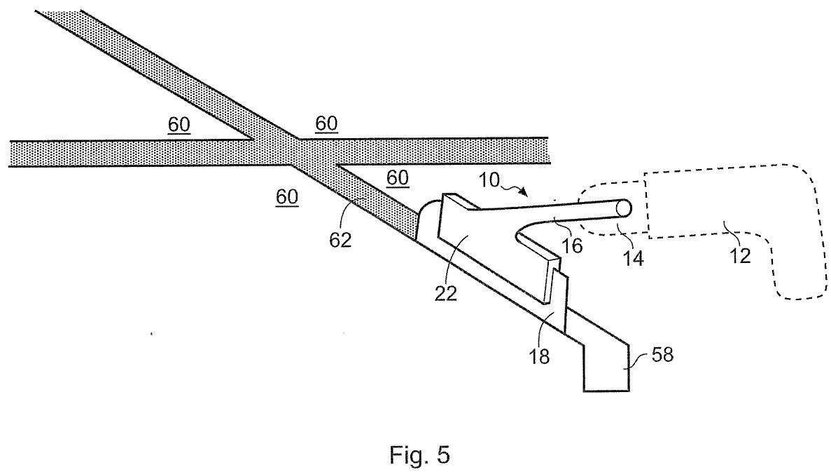

FIG. 5 is a perspective view of the attachments of FIG. 1, during use;

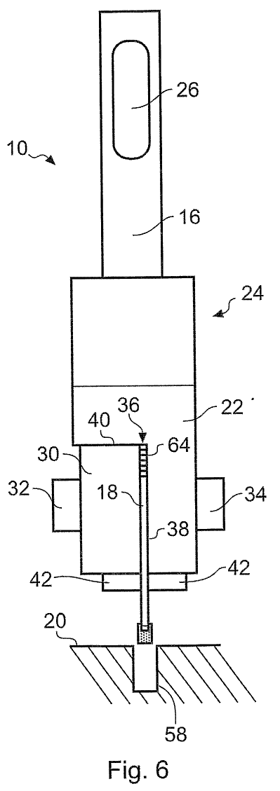

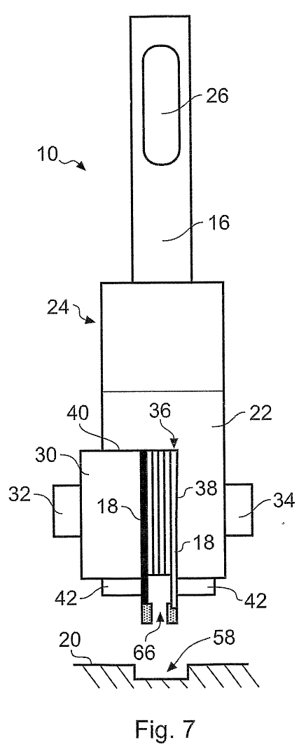

FIGS. 6 and 7 are side elevations corresponding with FIG. 2, with blade portions adjusted to alternative positions;

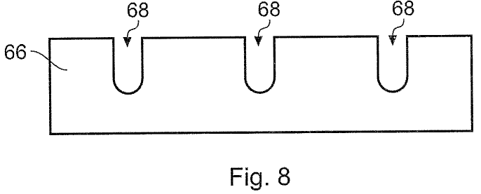

FIG. 8 is a front elevation of a spacer for use in the arrangement of FIG. 7;

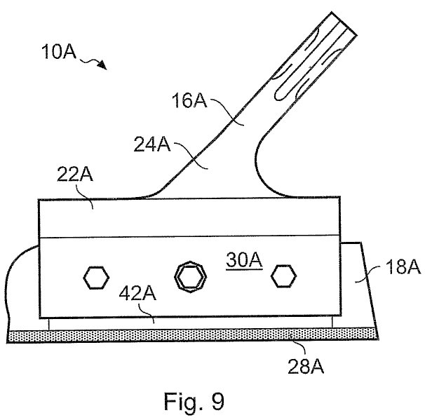

FIG. 9 corresponds with FIG. 1, showing an alternative example with a fixed shaft; and

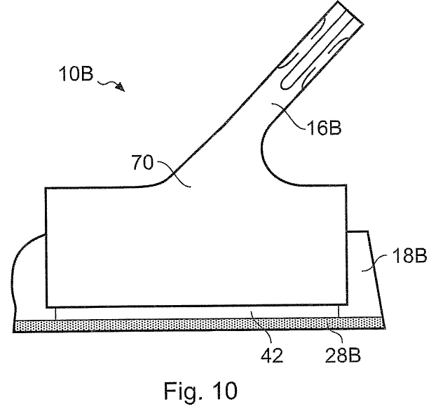

FIG. 10 corresponds with FIGS. 1 and 9, showing a further alternative moulded example.

FIG. 1 illustrates an attachment 10 for a powered hammer tool illustrated schematically by broken lines at 12. The tool has a chuck 14. The attachment 10 has a connection portion 16 in the form of a shaft for connecting the attachment 10 with the tool 12, during use, by attachment in the chuck 14. The attachment 10 further has a blade portion 18 which, in use, is offered to a surface indicated at 20, and to which hammer blows are transmitted from the hammer tool 12, thereby causing the blade portion 18 to cut into the surface 20.

In more detail, the attachment 10 has a main body 22 to which the shaft 16 is attached generally at 24 by an articulated connection such as a swivel. An alternative position for the shaft 16 is illustrated in broken lines in FIG. 1. The shaft 16 may be a plain cylinder or may have surface formations 26 to improve the compatibility of the shaft 16 with the chuck 14. The blade 18 is formed of a strip of material, such as tempered spring steel, and is generally elongate, having a straight working edge 28. The blade 18 will be described in more detail below. The blade 18 is held in the attachment 10 by a clamp arrangement formed by a clamp member 30 and clamping bolts 32 which extend through the clamp member 20, blade 18 and main body 22 and carry nuts 34 allowing the clamp member 30 to be tightened against the main body 22 to grip the blade 18.

The clamp member 30 and blade 18 are received in a rebate 36 in the main body 22 (see FIG. 2), having a first surface 38 against which the blade 18 is clamped, and a second surface 40, generally perpendicular to the shaft 16 when viewed from the side (FIG. 2). In the arrangement of FIG. 2, it can be seen that the blade 18 abuts the second surface 40 at its edge opposite to the working edge 28.

The main body 22 and clamp member 30 carry cushion bodies 42 located alongside the blade 18, but with the blade 18 projecting beyond the cushion bodies 42. In this example, separate cushion bodies 42 are provided to either side of the blade 18 but in alternative arrangements, particularly in the event that the blade 18 is narrower (in front elevation as FIG. 1) than the main body 22 and clamp member 30, the cushion bodies 42 could be replaced by a single cushion gasket extending entirely around the blade 18.

The blade 18 can be described in more detail, by reference to FIG. 4.

The working edge 28 is a straight edge which, in this example, is further enhanced for cutting by the provision of a cutting medium such as a cutting grit. For example, tungsten carbide grit may be used. This improves the expected working life of the blade 18. However, the replaceable and thus disposable nature of the blade 18 may make this unnecessary for some applications.

Behind the working edge 28, the blade 18 has three slots 14 with spacings which correspond with the spacing of the bolts 32, which are received in respective slots 44 when the blade 18 is mounted in the attachment. The slots 44 are generally elongate and generally parallel, allowing the blade 18 to slide toward or away from the second surface 40, prior to the clamp bolts 32 being tightened.

One end 46 of the blade 18 is a straight edge which meets the working edge 28 at the extreme end 48 at an acute angle. The other end 50 of the blade is curvaceous, having a concavity 52 which leaves a convex nib 54 at the other extreme end 56 of the working edge 28. These formations affect the manner in which the blade performs when moving through a workpiece, parallel to the direction of the working edge 28, as will be described in more detail below.

When the attachment 10 is assembled as illustrated in FIGS. 1 to 3, with the shaft 16 in the chuck 14 of the tool 12, the tool 12 may be operated to apply a hammer action to the shaft 16. The hammer blows are transmitted through the shaft 16 and attachment 24 to the main body 22, and from the main body 22 to the blade 18 by engagement of the second surface 40 with the blade 18. Consequently, the hammer blows are transmitted from the hammer tool 12 to the working edge 28. The working edge 28 can therefore be offered to a surface 20 and will cut into the surface 20, by virtue of the hammer action. In particular, movement of the working edge 28 across the-surface 20 will result in the formation of a channel 58. The depth of the channel 58 is set by the spacing of the working edge 28 from the cushion bodies 42. At the maximum depth of the channel 58, the cushion bodies 42 will engage the surface 20, preventing further penetration of the blade 18 into the surface 20, but also cushioning the surface 20 from hammer blows applied through the main body 22 or clamp member 30.

During these passes along the channel 58, the angle of the shaft 16 to the main body 22, at the pivot 24, may change, either as obstructions are encountered or as the user holding the tool 12 extends their reach or changes their posture.

The different shapes of the blade ends at 48, 56 will affect the performance of the blade 18 when cutting as described. For example, it is envisaged that the acute angle at 48 will be beneficial in cutting fresh material to form a channel 58, whereas the nib 54 will be advantageous in clearing material from a partially cut channel 58.

One application particularly envisaged for the attachment being described is for removing (or “raking”) grout from between existing tiles, to allow the tiles to be re-grouted or removed. This application is illustrated schematically in FIG. 5. The attachment 10 is running between adjacent tiles 60, powered by the tool 12, to cut into the grout 62, removing the grout from between the tiles 60, leaving a channel 58. It is envisaged that the acute angled end 48 will be used to cut into the grout 62 on a first pass, with a further pass being used to remove grout by means of the nib 54 at the other end of the blade 18. Throughout this operation, the depth of the channel 58 is controlled by the separation of the working edge 28 from the cushion bodies 42. Furthermore, the surface of the tiles 60 is protected from hammer blows by the cushion bodies 42. Tile surfaces may be delicate, particularly at the edges and particularly in the case of ceramic tiles and particularly under impacts such of those from a powered hammer tool.

Many different types of tool may be used to apply hammer action to the shaft 16. For example, the tool 12 may be operable exclusively to provide hammer action, or may be a hammer drill having the facility for disabling the rotary drive, so that only hammer action is provided to the chuck 14.

It has been noted that the maximum depth of the channel 58 is set by the separation of the working edge 28 and the cushion bodies 42. This can be adjusted by means of the slots 44 and bolts 32, prior to clamping the blade 18 into position. FIG. 6 illustrates the attachment 1.0 set up with the blade 18 projecting to a greater distance from the cushion bodies 42 than is shown in FIGS. 1 to 3. This results in a deeper channel 58. The clamping action between the clamp member 30 and the main body 22 may be adequate to transmit the hammer blows to the blade 18, without abutment between the blade 18 and the surface 40. However, it is preferred that when the blade 18 is advanced, as shown in FIG. 6, the resultant gap between the blade 18 and the second surface 40 is filled with a filler strip which abuts the second surface 40 and also the rear edge of the blade 18. This provides direct transmission of hammer blows by abutment, without relying on frictional engagement achieved by clamping.

It is envisaged that a user may be provided with a set of fillers 64 of different sizes, to allow the blade 18 to be set as described at various different positions relative to the cushion bodies 42, while retaining abutment between the blade 18 and filler 64, and between the filler 64 and surface 40.

Comparison of FIGS. 3 and 6 illustrates how the depth of the channel 58 can be determined by appropriate set up of the attachment 10. In addition, the width of the channel 58 can be selected, as can now be described with reference to FIG. 7. In FIG. 7, two blades 18 are held between the clamp member 30 and main body 22, each being of the type described above. The blades 18 are separated by one or more spacer members 66, one example of which is illustrated in FIG. 8. The spacer 66 is a simple rectangle of sheet material, having opened ended slots 68 formed along one edge, with spacings corresponding to the spacing of the slots 44 in the blades 18. Accordingly, the slots 68 can receive the bolts 32 when the arrangement is assembled as shown in FIG. 7. The open ended nature of the slots 68 allows the spacers to be readily introduced or removed from between the blades 18, by loosening the clamp arrangement, in the event that a different channel width is required, but without requiring complete dismantling of the bolts 32, nuts 34 and clamp member 30. Accordingly, it can be understood from FIG. 7 that the separation of the blades 18 can be set as required, by using the appropriate number of spacers 66.

When the attachment 10, set up as illustrated in FIG. 7, is offered to the surface 20, the resultant channel will be wider than that formed by a single blade 18 as illustrated in FIGS. 1 to 3. Each blade portion 18 will define one edge of the channel. If a still wider channel is required, it may be appropriate to introduce additional blades at intermediate portions, so that several blades are cutting at different positions across the width of the channel. Furthermore, it can be understood that the depth of the channel can be set as described above, independently of the channel width.

Other examples of attachments are shown in FIGS. 9 and 10. Many features of these examples correspond with those of the examples previously described. Corresponding features are therefore given the same reference numerals as above, with the suffix A in FIG. 9 and the suffix B in FIG. 10.

The attachment 10A of FIG. 9 differs from the example described previously, primarily in that the shaft 16A is attached to the main body 22A at a fixed angle at 24A. This results in an arrangement which is expected to be simpler to manufacture, and therefore cheaper, and which also removes the requirement to design a pivot capable of transmitting power blows. For example, the shaft and main body can be cast as a single item. However, it becomes necessary to maintain a constant attitude of the tool 12 and attachment 10, relative to the surface 20, for efficient working, which may be inconvenient or uncomfortable in some circumstances.

The attachment 10B of FIG. 10 is a simpler construction than the examples previously described and is envisaged as a disposable product. In the attachment 10B, a single body 70 is moulded around the blade 18B to hold the blade 18B and also provide the shaft 16B. Cushion members or a cushion gasket 42 are then provided. It is envisaged that the body 70 can be moulded from a plastics material which is sufficiently hard to transmit the hammer blows, but sufficiently cheap to be used on a disposable basis. This example has a fixed angle between the shaft 16B and the rest of the attachment 10B, and there is no facility to vary the width or depth of the channel formed.

It is envisaged that the attachments described above can be used for forming channels in a wide variety of surfaces, including grout removal between tiles of many different types, such a decorative wall tiles, hard floor tiles, waterproof swimming pool grade tiles and the like, and with various different types of grout. When starting to form a channel, it may be desirable to provide initial hammer blows at a relatively low rate, increasing speed as the blade begins to break up the grout. Similarly, it is desirable to provide a steady increase in the pressure with which the blade is pressed against the grout.

Attachments and their components can be manufactured from a wide range of materials, capable of performing satisfactorily under the loads likely to be experienced, during use. For example, metal or plastic impact resistant castings can be used for the main body of the attachment. The shaft may be of tempered steel and the blade may be of tempered spring steel. Fillers may also be of tempered steel. Spacers may be of mild steel. Cushion bodies may be of polyurethane or other resilient material. However, the skilled reader will readily understand the functional requirements of each of the components, and therefore be able to choose an appropriate construction material for an intended application. Similarly, dimensions and relative dimensions, shapes and forms of the various components can be widely varied without departing from the scope of the invention.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An attachment for a powered hammer tool, having a connection portion for connecting the attachment with a tool, during use, and a blade portion which, in use, is offered to a surface and to which, in use, hammer blows are transmitted from the hammer tool, thereby causing the blade portion to cut into the surface.

2. An attachment according to claim 1, wherein the blade has an elongate working edge.

3. An attachment according to claim 2, wherein the working edge is straight.

4. An attachment according to claim 2, wherein the blade is formed at one end of the working edge to have a concavity away from the working edge, forming a convex nib at the end of the working edge.

5. An attachment according to claim 2, wherein the blade is formed at one end of the working edge to have an edge extending away from the working edge and meeting the end of the working edge at an acute angle.

6. An attachment according to claim 2, comprising a cutting medium carried by the blade at or near the working edge.

7. An attachment according to claim 6, wherein the cutting medium is a hard grit.

8. An attachment according to claim 7, wherein the medium is tungsten carbide grit.

9. An attachment according to claim 1, having a cushion portion associated with the blade, the blade projecting beyond the cushion portion by a projection length which defines the depth to which the blade is able to penetrate the surface.

10. An attachment according to claim 9, wherein the blade is adjustable in position relative to the cushion portion, to set the maximum depth of penetration into the surface.

11. An attachment according to claim 9, wherein the or a cushion portion is provided to both sides of the blade.

12. An attachment according to claim 9, wherein the or a cushion portion is provided by a gasket extending around the blade.

13. An attachment according to claim 9, wherein the or a cushion portion is provided by a plurality of separate cushion members.

14. An attachment according to claim 1, wherein the blade is removable from the connection portion.

15. An attachment according to claim 1, wherein the connection portion comprises a main body, and a clamp arrangement to clamp the blade to the main body.

16. An attachment according to claim 15, wherein the clamp arrangement includes at least one elongate clamp member which extends through the blade.

17. An attachment according to claim 16, wherein the clamp member extends through a slot in the blade, the slot allowing the blade position to be adjustable when the clamp arrangement is tightened.

18. An attachment according to claim 1, wherein the main body has a surface through which hammer blows are transmitted to the blade when in abutment therewith, there being a filler member locatable between the blade and the surface when the blade is spaced away from the surface, to convey hammer blows through the filler member to the blade.

19. An attachment according to claim 1, wherein the connection portion is adapted to receive a plurality of spaced blades.

20. An attachment according to claim 19, wherein the spacing of the blades is adjustable.

21. An attachment according to claim 20, comprising spacer members locatable between spaced blades to maintain a spacing set by the thickness and/or number of spacers.

22. An attachment according to claim 1, wherein the blade and connection portion form a unitary article.

23. An attachment according to claim 22, wherein the connection portion is moulded around the blade.

24. An attachment according to claim 1, wherein the connection portion comprises a main body carrying the blade portion, and a shaft connected to the main body to be received, in use, by the powered hammer tool.

25. An attachment according to claim 1, comprising an articulated connection between the shaft and the main body.

26-27. (canceled)
